(19) United States
(12) Patent Application Publication
(10) Pub. No.: US 2016/0249085 A1
(43) Pub. Date: Aug. 25, 2016

(54) DEVICE, SYSTEM, AND METHOD OF ADVERTISING FOR MOBILE ELECTRONIC DEVICES

(71) Applicants: Yaniv Ben-Atiya, Petach Tikva (IL); Yannay Hanegbi, Ramat Hasharon (IL)

(72) Inventors: Yaniv Ben-Atiya, Petach Tikva (IL); Yannay Hanegbi, Ramat Hasharon (IL)

(21) Appl. No.: 15/050,476

(22) Filed: Feb. 23, 2016

Related U.S. Application Data
(60) Provisional application No. 62/119,828, filed on Feb. 24, 2015.

(51) Int. Cl. H04N 21/2547; H04N 21/234; H04N 21/845; H04N 21/854; H04N 21/2387; H04N 21/6543; H04N 21/4363; H04N 21/81; G11B 27/10

(52) U.S. Cl. CPC H04N 21/2547; H04N 21/812; H04N 21/23424; H04N 21/8456; G11B 27/10; H04N 21/2387; H04N 21/6543; H04N 21/43637; H04N 21/85406

(57) ABSTRACT

A system includes a video advertisements control unit to enable serving of a video advertisement to a mobile electronic device. A tag sending unit sends a unique tag to multiple advertising supply side servers. A mobile video player loader unit automatically loads a mobile video player upon parsing of the unique tag. Waterfall loader unit automatically loads, concurrently, a unique waterfall data structure including a prioritized list of advertising demand-side resources. An advertiser selector unit analyzes the prioritized list, and selects a particular advertiser which offers to pay a maximum price for a video advertising impression relative to other advertisers on said prioritized list. A video advertisement reconstruction unit converts or reconstructs the video, as a sprite-sheet or as a set of discrete images. A player starter unit automatically triggers operation of a mobile video player that was loaded onto the mobile electronic device, to playback a reconstructed video item.

### CROSS-REFERENCE TO PRIOR APPLICATIONS

This utility patent application claims priority and benefit from U.S. provisional patent application No. 62/119,828, filed on Feb. 24, 2015, which is hereby incorporated by reference in its entirety.

### FIELD OF THE INVENTION

The present invention relates to the field of advertising on mobile electronic devices.

### BACKGROUND

Millions of people worldwide utilize mobile electronic devices, for example, smartphones, tablets, smart-watch devices, phone-tablet (“phablet”) devices, or the like. Users utilize such devices for a variety of purposes, for example, to browse the Internet, to send and receive electronic mail (e-mail), to send and receive Instant Messaging (IM) messages, to consume audio and video, to read textual content, to play games, or the like.

Some web-sites, web-pages, and applications (“apps”) for mobile electronic devices, may present advertisements to the user. Such “mobile advertising” may include, for example, displaying a banner advertisement on the mobile device, during the operation of a mobile application. The effectiveness of mobile advertising may be measured in a variety of ways, for example: number of impressions (views); click-through rate; conversion rate.

### SUMMARY

The present invention may include, for example, devices, systems, and methods of advertising for mobile electronic devices (e.g., smartphone, tablet, smart-watch). The present invention may enable efficient real-time bidding of advertisers, in a manner that may maximize fill-rate, aggregate profit, and/or system efficiency.

For example, a system may include a video advertisements control unit to enable serving of a video advertisement to a mobile electronic device. A tag sending unit sends a unique tag to multiple advertising supply side servers. A mobile video player loader unit automatically loads a mobile video player upon parsing of the unique tag. Waterfall loader unit automatically loads, concurrently, a unique waterfall data structure including a prioritized list of advertising demand-side resources. An advertiser selector unit analyzes the prioritized list, and selects a particular advertiser which offers to pay a maximum price for a video advertising impression relative to other advertisers on said prioritized list. A video advertisement reconstruction unit converts or reconstructs the video, as a sprite-sheet or as a set of discrete images. A player starter unit automatically triggers operation of a mobile video player that was loaded onto the mobile electronic device, to playback a reconstructed video item.

The present invention may provide other advantages and/or benefits.

### BRIEF DESCRIPTION OF THE DRAWINGS

FIGS. 1A-1B are schematic block-diagram illustrations of a system in accordance with some demonstrative embodiments of the present invention;

FIGS. 2A-2F are flow-charts of a method in accordance with some demonstrative embodiments of the present invention.

### DETAILED DESCRIPTION OF THE PRESENT INVENTION

In the following detailed description, numerous specific details are set forth in order to provide a thorough understanding of some embodiments. However, it may be understood by persons of ordinary skill in the art that some embodiments may be practiced without these specific details. In other instances, well-known methods, procedures, components, units and/or circuits have not been described in detail so as not to obscure the discussion.

The present invention may comprise a video advertisements player for mobile electronic devices, combined with a back-office waterfall module for video demand source optimization and for other optimizations. The present invention may enable mobile publishers to increase their revenues and/or efficiency, by providing a solution to present or display video ads to their mobile users (e.g., who utilize a portable electronic device), without requiring complicated integrations or client-side products or modules. The system of the present invention may provide a full end-to-end solution, and may provide the technology and the ads themselves from the advertisers, thereby maximizing or increasing the long-term yield and/or increased revenue for the publisher, and/or otherwise improving the yield of marketing efforts and/or marketing budgets.

The present invention may operate in conjunction with various types of mobile advertising, namely, advertising via smartphones, tablets, phablets, smart-watch devices, portable electronic devices, Augmented Reality (AR) devices or glasses or headsets or helmets or headgear or gear, Virtual Reality (VR) devices or glasses or headsets or helmets or headgear or gear, sports-tracking devices or bracelets or “fitness bracelets” that are wearable or portable (e.g., wearable around the wrist), and other suitable mobile electronic devices. The mobile advertising in accordance with the present invention may provide customers with time and location sensitive, personalized information that promotes goods, services and/or ideas. The present invention may operate with various mobile operating systems, for example, IOs (Apple), Android (Google), Windows (Microsoft), or others. The present invention may be utilized by various types of publishers (media producers), with various native apps, and with mobile web apps (e.g., responsive and non-responsive sites).

The present invention may operate with various types of mobile advertising, for example: mobile Web Banner (top of page) or Mobile Web Poster (bottom of page) banner; Video ads in apps or web-apps; In-apps ads, ads on top of mobile videos, or during mobile TV receipt; fullscreen interstitials, which appear while a requested item of mobile content or mobile web page is loading up; SMS advertising; MMS advertising; Audio advertisement (e.g., an audio jingle before a voicemail recording, or an audio recording played while interacting with a telephone-based service such as movie ticketing or directory assistance); rich media (based on MRAID and/or HTML5 technology); and/or other suitable types of mobile advertising.

The present invention may be utilized in conjunction with various methods of measuring the effectiveness of mobile media ad campaigns; for example, impressions (views) and click-through rates; in conjunction with Cost Per Impression campaigns, or click-through/Cost Per Click campaigns; in conjunction with campaigns that measure conversion rates, such as click-to-call rates and other degrees of interactive measurement, as well as Cost Per Install (CPI) campaigns where the pricing model is based on the user installing an App on their mobile device.

The present invention may allow an ad network operator to enable mobile publishers (e.g., publishing through mobile native apps and/or mobile web apps)—to display video ads to their mobile users, and to increase their revenue and profitability.

The Applicants have realized that multiple barriers may exist in the mobile video ads industry. Since this is a fast growing industry with many players and new technologies, finding and applying a solution of displaying video ads for the majority of publishers may be an exceptionally difficult goal to achieve; as there are several barriers of selling ads in the industry, including for example: (1) Hard to find apps that have players which support Video Ad Serving Template (VAST); (2) By default, many conventional players do not support a large set of video types (such as FLV), and may only supports MP4 or WEBM; (3) In traditional systems, without any player, the publisher can only run a video file (MP4) whereas the mobile device's native video player will run the video and lack all trackers that the advertisers need (e.g., in order to measure effectiveness of campaign); (4) The majority of advertisers expects that video will run on auto-play, such that the video will run and automatically begin playing whenever the ad is presented to the user, without requiring the user to press “play”; and an ad network is often paid based on user views; and if the video ad is not auto-played (namely, does not auto-starts) then the ad network may not be profitable; and conventional solutions (e.g., HTML5 video players) may not be able to provide auto-play of video ads.

The system of the present invention may be utilized by multiple stakeholders of users or entity, for example: (1) Demand-Side Platform (DSP) systems or entities (Demand side), for example, a system that allows buyers of digital advertising inventory to manage multiple ad exchange and data exchange accounts through a unified interface. (2) Publishers (Supply side), for example, mobile sites, mobile apps (IOS and Android), and any publisher with mobile traffic relevant for mobile devices including smartphones, tablets, game consoles, portable gaming devices, smart-watch devices, smart TV, or the like. (3) Advertisers (Demand side), for example, buyers of digital video advertising inventory who operate through ad exchange and data exchange accounts, or directly with publishers and networks.

In some embodiments, the system of the present invention may operate in accordance with the following computerized method: (1) The system sends to supply side partners the system's tag; for example, an HTML fraction or code-segment that enables (or causes, or triggers) a website or a recipient to serve an impression of an ad. (2) When the tag is loaded (an impression), it starts to load the system's mobile video player, and concurrently it loads the specific waterfall for this publisher; the “waterfall” may be, for example, a prioritized list of demand sources controlled by publishers; for example, the advertisers that are willing to pay the most to reserve inventory and reach the largest audience get their ads served first; such that this practice may maximize the revenue for the publisher. (3) In the waterfall, the system goes through the demand sources list (advertisers) until there is found an advertiser that wants to buy this impression. (4) The system recognizes the video source type, and splits the video to multiple strips (or slices, or epochs) of K images per strip (wherein K is a natural number, for example, 4 or 6 or 8 or 10 or 16 or 32 images per strip). (5) The system re-builds the video from the sliced strips, and reformats the VAST to a JavaScript tag. (6) The mobile video player is started, it tracks the user's events and sends them to the system's server, as well as to the advertiser.

Some implementations may utilize VAST, which is Video Ad Serving Template; for example, the mobile video player of the present invention may be VAST-compliant, which knows how to read the VAST (template), reads the XML tags, and display the mobile video while also supporting all trackers.

Some implementations may utilize, or may be used in conjunction with, Responsive sites which may dynamically modify their look-and-feel to accommodate the mobile device's interface and properties (e.g., screen size, screen orientation, resolution, interface components); in contrast with non-responsive sites.

In some implementations, the system may utilize and support the following parameters or attributes or characteristics, for selecting, processing and/or serving a mobile advertisement: (1) An attribute indicating whether the video will auto-play (auto-start), or needs to be user initiated to start playing. (2) Platforms attribute, supporting native apps and/or mobile web apps. (3) Supported size(s), including any mobile supported sizes; for example, 300 by 250 pixels; or 320×480 pixels (e.g., optionally presented as 300×250 pixels on some screens, such as on a 320×480 black screen). (4) Support for flexible advertisement location; locating or positioning or placing the mobile video ad on the publisher's app or site in an easy and flexible manner. (5) Default mute; such that, only when the user clicks on the audio icon, the audio will be synced to the video, and the user will hear the audio. (6) Support for any suitable video format. (7) Support for Scroll-View, or View-ability Checker, such that if the ad is presented “below the fold” then the ad will load only if and when the user actually scrolls down below the fold. (8) Support for all trackers and events, for example, specified in the Interactive Advertising Bureau (IAB) VAST standard. (9) Support for Waterfall ordering; the campaign manager decides the order for the demand side (advertisers); when the system loads the waterfall configuration, it sends in real-time according to the order that was set, and/or in accordance with fill-rate and/or profitability. (10) Support for waterfall recall; the system may call to the same advertisers several times in the waterfall in order to get higher fill rates; (11) support for Waterfall flexibility, such that every advertiser may have a different VAST format, and the system dynamically changes the system's configuration in real-time in order to serve its demand partners information requests. (12) Support for VAST response types, including support for recursive loops in VAST responses; including (12A) Linear operation, sending the mobile player and/or the VAST and/or other information together with the video ad itself; and (12B) Wrapper support, sending the mobile video ad with another VAST call that holds the video, optionally utilizing several levels. (13) Loop support, presents to the same user several videos in a loop. (14) VPaid support, as well as support for other current and/or future video protocols. (15) Support for supply-side macro.

In some embodiments, the system may utilize a computerized method or program in accordance with the following steps or method or pseudo-code.

Step 1: When a publisher tag is loaded, it calls to the controller JavaScript that gets all parameters from the tag.

Step 1.1: Loads the mobile video player.

Step 1.2: Loads the file that is in charge of reading the VASTs that are in the specific waterfall.

Step 1.3: Sends two parameters: (a) link to the waterfall's XML; (b) trackers object with default values.

Step 2: According to the waterfall ID parameter, it reads VASTs according to their order in the XML file (namely, according to the specific waterfall); adds custom trackers for the specific VAST; and tries to get the link for video (e.g., MP4, FLV, WEBM).

Step 2.1: A user device detection service is used to obtain and add additional data that may be passed to the VAST; such as, device type, device make, device model, connection type, user agent, Internet Protocol (IP) address.

Step 2.2: In some cases, the VAST may return a 302 redirect, which may not be supported on XML-HTTP calls. This may be solved by adding an additional proxy service that performs the call from the server and return a finalURL to the JavaScript client.

Step 2.3: If the VAST would not include a video, it will have another VAST inside it, and the process will work recursively.

Step 2.4: Each VAST contains trackers per event, for example, as specified in the IAB VAST standard; the system may insert each tracker event into a relevant bucket; and all the trackers in each bucket will be called per event.

Step 2.5: If the original VAST or the internal VAST has no demand, then the system will reset the buckets to the default setting.

Step 2.6: Waterfall recalls: for each waterfall run, the system may try to look for a demand multiple times. Since the system is Real-Time Bidding (RTB) enabled, in some cases a demand response may change even within milliseconds.

Step 2.7: If the video is not supported, or there is no demand from the advertiser, the system will skip to the next VAST in the waterfall.

Step 2.8: When all waterfall's VAST tags return no demand, then the system calls to the system's filler tag; which may be a banner or any action that the publisher would like the system to perform when no demand is found or met.

Step 3: The mobile video player is initiated, and gets or receives or obtains the video link as a parameter with additional parameters (e.g., width and height of the video to be played).

Step 4: Handling the Video Player load:

Step 4.1: Converting Video Ads into images—Asynchronously the video player calls to a wrapper for an external service, or other suitable service or module or algorithm that handles or converts video into a set of images.

Step 4.1.1: To optimize the process, so the user will get the video faster and to reduce delays or latency, the wrapper identifies whether or not the external service processed this video; and only if not, the wrapper gets the external service for the video link.

Step 4.1.1(A): Generating a batch or set of multiple frames (which may be consecutive or non-consecutive), from the video that is sent.

Step 4.1.1(B): All images are automatically synced to the Content Delivery Network (CDN) to improve performance.

Step 4.1.1(C): The system gets from this service, the folder in which all images are placed, and an indicator of whether or not the video includes audio.

Step 4.2: In the meantime, or in parallel or concurrently, the mobile video player constructor prepares the mobile video player appearance (interface, interface components) including size, buttons, style, colors, background, and/or other parameters or components.

Step 4.3: Once the mobile video player is ready, it is injected into the HTML page to be served to the end-user device.

Step 4.4: Now, the end-user device will see the mobile video player, which may present a “spinner” (or other counter or progress-bar) to indicate that it is loading (receiving) the movie (namely, receiving the mobile movie file).

Step 4.5: When the “sprite sheet” folder is ready with all images that complete the mobile video, the mobile video player will identify or determine whether or not there is audio that accompanies the video; and may determine if it should present the “mute” button.

Step 4.6: The mobile video player sends back an indicator that it ready to run (to play-back) the mobile video.

Step 5: The controller JavaScript starts the video player, and listens to events. For every event that occurs, the controller fires or triggers or launches the adequate tracker/s. Some implementations may support all IAB events, including custom events. A demonstrative list of supported events is shown further herein below.

Step 6: Perform and log Real-Time analytics:

Step 6.1: All events are logged in real-time in a repository or a “big data” platform, and may be presented to the analyst via a powerful User Interface (UI); thereby allowing to perform optimization action(s) substantially in real-time.

Step 7: Once the mobile video ad is playing, the system may start to process the loop:

Step 7.1: According to a parameter that is implemented in the publisher tag; when the system runs the loop, the method is repeated or performed again or iteratively, from step (4) above and onward.

Step 7.2: The system gets or obtains the video-ad from the demand sources, and prepares the mobile video-ad.

Step 7.3: Once the mobile video player fires or triggers an event, indicating that the player finished the current video presentation, the mobile video player gets the new mobile video ready to be presented to the user.

Step 7.4: The new mobile video may be presented to the user continuously and without any halt, thereby allowing the system as well as the supply partners to get more demand on the same user, and maximize the profit.

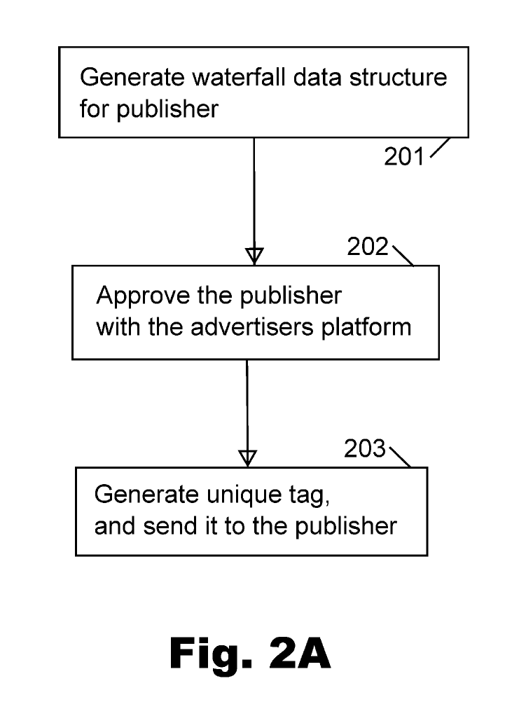

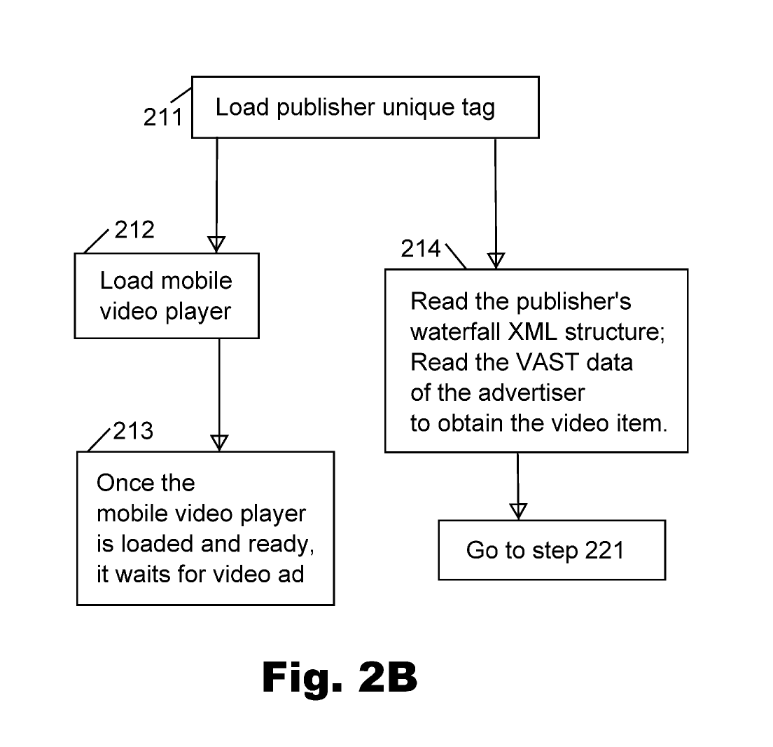

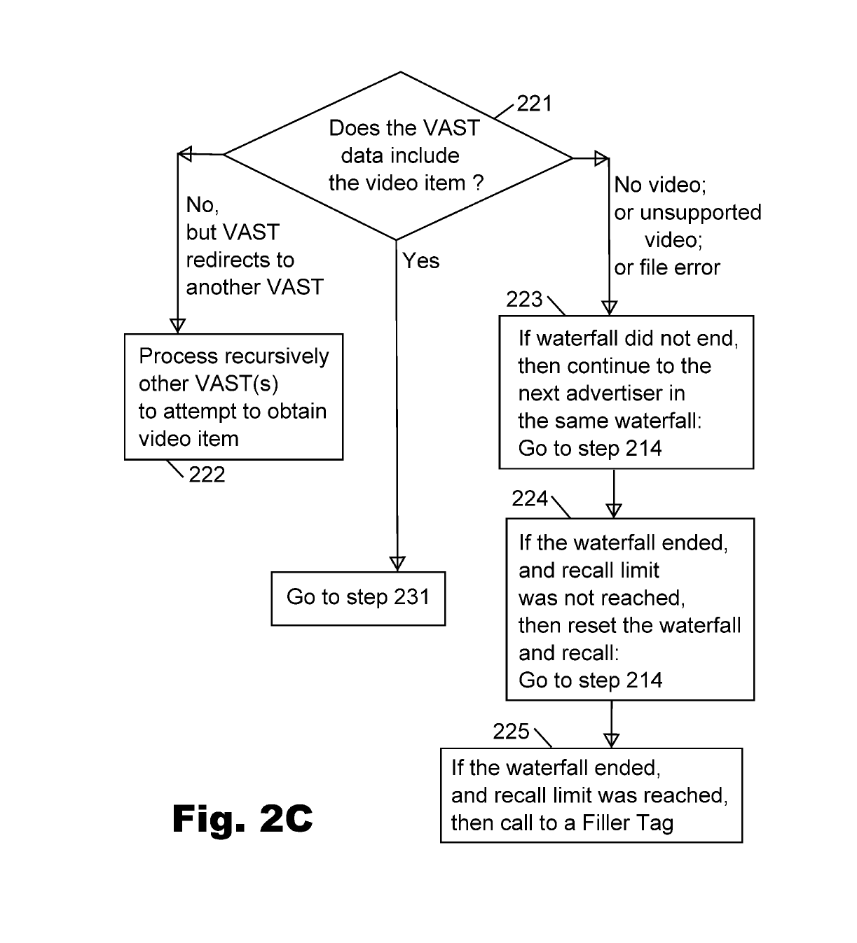

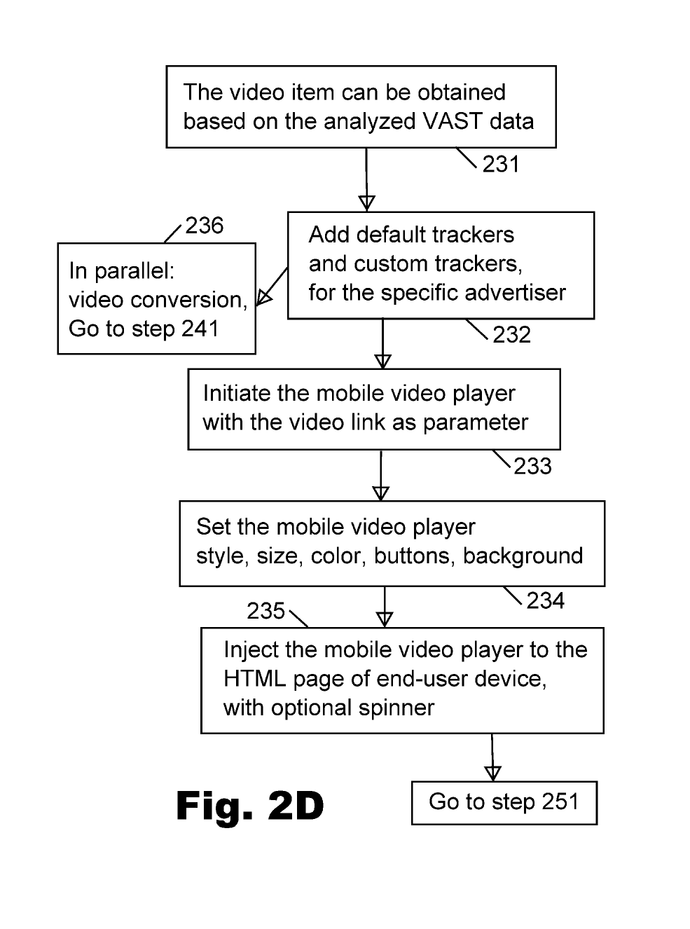

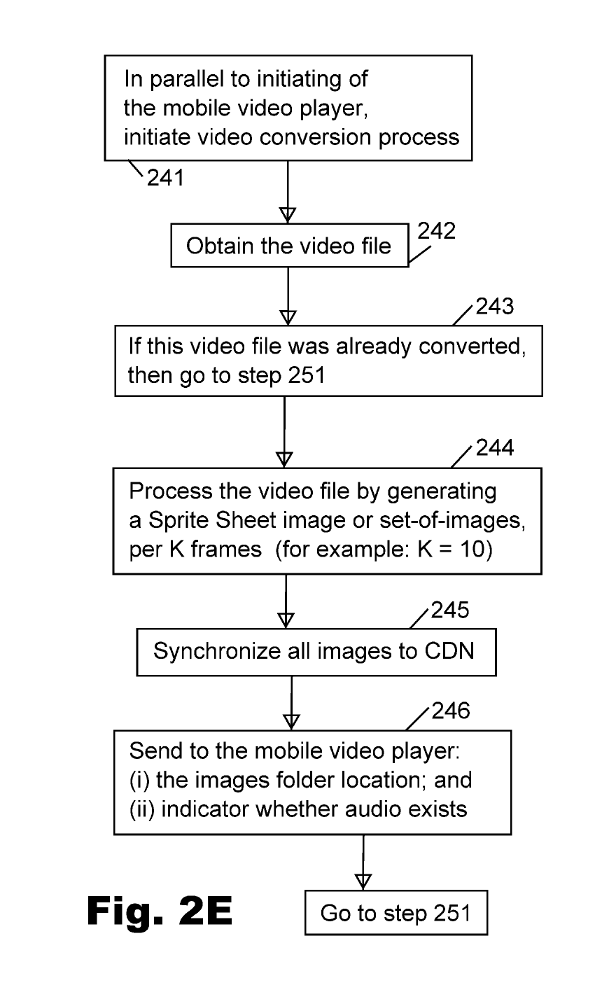

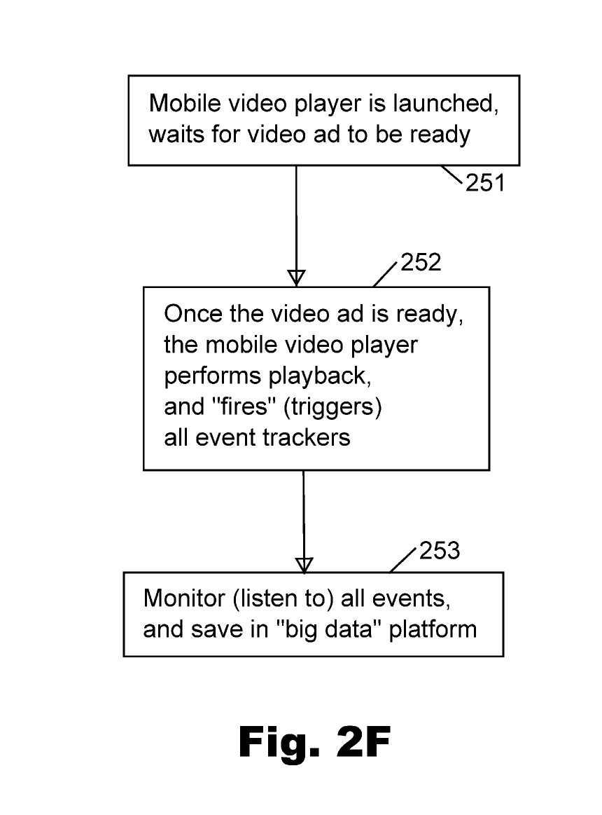

Some embodiments may comprise a computerized method in accordance with the flow-chart that is shown in FIGS. 2A-2F.

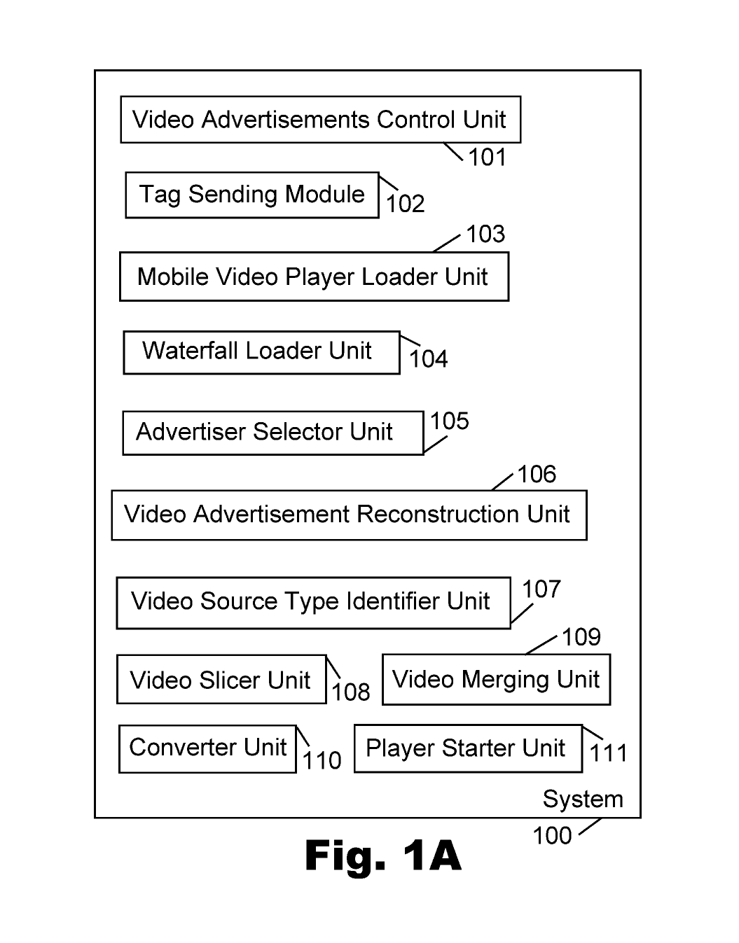

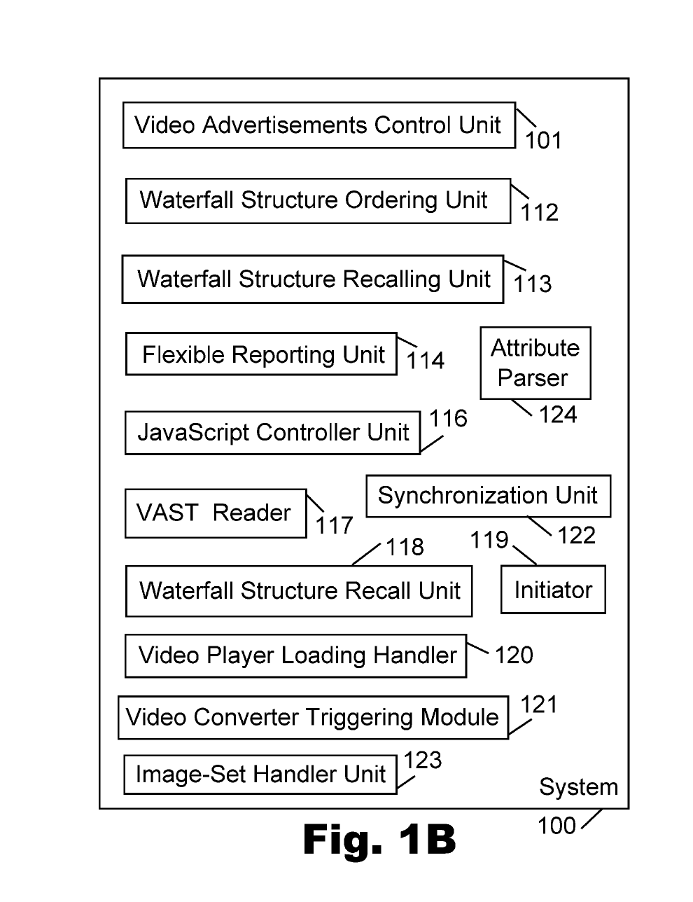

Reference is made to FIGS. 1A-1B, which are schematic block-diagram illustrations of a system 100, in accordance with some demonstrative embodiments of the present invention. In order to avoid over-crowding of the drawing, the components of system 100 are shown as distributed over FIG. 1A and FIG. 1B; however, some or all of the components of FIGS. 1A-1B may co-exist and/or may be co-located within the same system 100. Accordingly, system 100 may comprise some or all of the components shown in FIG. 1A, as well as some or all of the components shown in FIG. 1B.

For example, computerized system 100 may comprise: a video advertisements control unit 101 to enable serving of a video advertisement to a mobile electronic device, wherein the video advertisements control unit comprises: (a) a tag sending module 102 to send a unique tag, that is associated with said server computer, to a plurality of advertising supply side servers; (b) a mobile video player loader unit 103, to automatically load a mobile video player upon parsing of said unique tag; (c) a waterfall loader unit 104, to automatically load, concurrently with step (b), a unique waterfall data structure comprising a prioritized list of advertising demand-side resources; (d) an advertiser selector unit 105, to analyze said prioritized list of advertising demand-side resources, and to select from said prioritized list a particular advertiser which offers to pay a maximum price for a video advertising impression relative to other advertisers on said prioritized list; (e) a video advertisement reconstruction unit 106, comprising: (I) a video source type identifier unit 107, to identify a source type of a video advertising item, and (II) a video slicer unit 108 to split the video advertising item to multiple video slices, and (III) a video merging unit 109 to selectively reconstruct a merged video content item from one or more of the multiple video slices, and (IV) a converter unit 110 to convert Video Ad Serving Template (VAST) data of said video advertising item into a corresponding JavaScript tag; (f) a player starter unit 111, to automatically trigger operation of a mobile video player that was loaded onto the mobile electronic device, to playback the merged video content item on the mobile electronic device.

In some embodiments, the tag sending module is to send to the plurality of advertising supply side server said unique tag which comprises an HTML code-segment that triggers a website to server an impression of a video advertisement.

In some embodiments, the tag sending module is to send to the plurality of advertising supply side server said unique tag which comprises an HTML code-segment that triggers a browser of a mobile electronic device to display on the mobile electronic device an impression of a video advertisement.

In some embodiments, the waterfall loader unit is to automatically load said unique waterfall data structure in which multiple advertisers are ranked based on an amount of price that each advertiser agrees to pay for video advertisement placement.

In some embodiments, the video advertisements control unit further comprises: a waterfall structure ordering unit 112, to re-order the prioritized list of advertising demand-side resources based on fill-rate; wherein an advertiser and a corresponding video content item are automatically selected based on a criterion that maximizes fill-rate of multiple video advertisements of multiple advertisers.

In some embodiments, the waterfall structure ordering unit 112 is configured to re-order the prioritized list of advertising demand-side resources based on aggregated profitability for an administrator of the video advertisements control unit; wherein an advertiser and a corresponding video content item are automatically selected based on a criterion that maximizes aggregated profitability for multiple video advertisements of multiple advertisers.

In some embodiments, the video advertisements control unit further comprises: a waterfall structure recalling unit 113, to recall a particular demand-side advertiser multiple time within a single waterfall structure that pertains to a single offered video ad impression.

In some embodiments, the waterfall structure recalling unit 113 is configured to recall a particular demand-side advertiser multiple time within a single waterfall structure that pertains to a single offered video ad impression, at multiple different time-points, based on a criterion that maximizes video advertisement fill-rate.

In some embodiments, the waterfall structure recalling unit 113 is to recall a particular demand-side advertiser multiple time within a single waterfall structure that pertains to a single offered video ad impression, at multiple different time-points, based on a criterion that maximizes video advertisement fill-rate.

In some embodiments, the video advertisements control unit further comprises: a modular or flexible reporting unit 114, (A) to automatically identify that a first advertiser utilizes a first VAST format; and (B) to automatically identify that a second advertiser utilizes a second, different, VAST format; and (C) to dynamically modify in real time a configuration of the video advertisements control unit to serve to each advertiser feedback information in a required VAST format.

In some embodiments, the video advertisements control unit comprises: a JavaScript controller unit 116, (a) to load a mobile video player immediately upon loading of a publisher tag, (b) to load a VAST reader file that reads one or more VAST structures that are associated with the waterfall data structure, (c) to generate at least (I) a link to an XML representation of the waterfall data structure, and (II) one or more tracker objects pre-populated with default values.

In some embodiments, the video advertisements control unit comprises also a VAST reader unit 117, (a) to read the one or more VAST data structures that are associated with the waterfall data structure according to a reading order that is determined based on order of appearance of the VAST data structures in the XML representation, (b) to add customized values into said one or more tracker objects based on actual content of the one or more VAST data structures; (c) to at least attempt to obtain a direct link for a video file intended for playback as said video advertisement item; (d) to fall-back to reading a second VAST data structure, indicated in said XML representation of the waterfall data structure, if a first VAST data structure is processed and returns at least one of: (I) no video advertisement demand by said first VAST, or (II) non-supported video file indicated by said first VAST.

In some embodiments, the VAST reader unit is (A) to detect that a particular VAST reading attempt returns a redirection response, and (B) to utilize a proxy service that performs a call from a computer server and obtains a non-redirecting URL to said JavaScript controller unit;

In some embodiments, the VAST reader unit comprises a recursive VAST handler, (A) to detect that a particular VAST reading attempt does not yield a direct link to a video file, and (B) to recursively extract an internal VAST data structure from said particular VAST, and (C) to recursively repeat steps (A) and (B) until successful extraction of said direct link to the video file.

In some embodiments, the system comprises: a waterfall structure recall unit 118, to enable Real-Time Bidding (RTB) on price offered for video ad placement, by repeatedly searching multiple times for a particular demand-side bid which changes over time due to said particular demand-side bid being continuously modified by a bidding server.

In some embodiments, the system comprises: an initiator module 119, (A) to initiate the mobile video player, (B) to obtain the link to the video file intended for playback, and (C) to obtain a width parameter and a height parameter of the video file intended for playback; and a video player loading handler 120, which may comprise: (A) a video converter triggering module 121, to asynchronously call to a wrapper for a computerized video converter unit to convert the intended video file into a set of discrete images; (B) a synchronization unit 122, to automatically synchronize the images of said set of discrete images to a Content Delivery Network (CDN); (C) an image-set handler unit 123, to obtain said set of discrete images, to store said set of discrete images as a sprite-sheet folder, and to obtain an indicator of whether or not said intended video file includes an audio track.

In some embodiments, the JavaScript controller unit is (I) to receive an indication, from the mobile video player unit, that said mobile video player unit is loaded and ready to run, and (II) then to trigger playback of the set of discrete images via said mobile video player, and (III) to monitor events occurring during playback, and (IV) to launch a corresponding event tracker upon identification of a monitored event.

In some embodiments, the video advertisements control unit further comprises: an attribute parser unit 124, (A) to parse a platform-constraint attribute indicating that said video content item is required by a corresponding advertiser to be served only to a mobile web application and not to a native non-web mobile application; and (B) to trigger playback of the video content item only through a mobile web application of the mobile electronic device, and not through a native non-web mobile application of the mobile electronic device.

In some embodiments, the attribute parser unit 124 is (A) to parse a platform-constraint attribute indicating that said video content item is required by a corresponding advertiser to be served only to a native non-web mobile application and not to a mobile web application; and (B) to trigger playback of the video content item only through a to a mobile web application of the mobile electronic device, and not through a mobile web application of the mobile electronic device.

In some embodiments, the attribute parser unit is (A) to parse an auto-start attribute indicating whether or not said video content item is required by a corresponding advertiser to auto-start playback, and (B) if said auto-start attribute so indicates, to trigger a mobile video player running on the mobile electronic device to auto-start playback of said video content.

In some embodiments, the attribute parser unit is (A) to parse a scroll-view attribute indicating whether or not said video content item is to be placed below a first fold of web-page; and (B) if said scroll-view attribute so indicates, to trigger a mobile video player running on the mobile electronic device to start playback of said video content only if and when said web-page was manually scrolled down from the first fold downwardly to show at least a portion of the mobile video player.

The various modules and/or units of system 100 may be co-located, or may be spread or distributed across multiple devices and/or across multiple locations; or may be implemented by using client-server architecture, centralized architecture, server computers, end-user devices, mobile electronic devices, peer-to-peer architecture, or the like. In some embodiments, the system may be implemented by using a particular-purpose machine that is not a general-purpose computer and is not a generic computer. In some embodiments, the machine and/or the system may optionally comprise a processor, a memory unit, a storage unit, an input unit, an output unit, a wireless communication transmitter and/or receiver and/or transmitter, a wired communication transmitter and/or receiver and/or transceiver, a network adapter card or component; a finance unit or monetary collection unit able to collect funds from advertisers and/or able to disburse funds to publishers, optionally associated with a clearinghouse server or service; and/or other suitable hardware units and/or software modules.

FIG. 2A shows preparatory or initial operations, which comprise: generating a waterfall data structure for a publisher (step 201); approving the publisher with the advertisers platform (step 202); and generating a unique tag, and sending it to the publisher (step 203).

The method may then continue with the operations shown in FIG. 2B, which comprise: loading the unique tag of the publisher (step 211). Then, the mobile video player is loaded (step 212), and once loaded and ready, it waits for a video ad (step 213). In parallel, the method may comprise (step 214): reading the publisher's waterfall structure, reading the VAST data of the advertiser to obtain the video item (e.g., to obtain a direct link to the video item, rather than obtaining an entire copy of the video file), and proceeding to step 221.

Turning to FIG. 2C, in step 221 the method may comprise: checking whether the VAST data includes the video item (e.g., a direct link to the video item). If the checking result is positive, then the method proceeds with step 231 and onward.

Alternatively, if the checking result is negative, and the VAST redirects to another VAST (or recursively to several VAST structures), then the method may process recursively (step 222) such other VAST(s) to attempt to obtain the video item (or a direct link to the video item).

Still alternatively, if the checking result is negative, because there is no video file, or the video file is in an unsupported format, or is corrupted or has a file error, then the method may proceed with steps 223, 224 and/or 225. For example, in step 223, if the waterfall did not end, then the method continues to the next advertiser in the same waterfall, and the operations repeat from step 214 and onward. If or when the waterfall ends, and a pre-defined recall limit was not yet reached, then a recall may be performed (e.g., by resetting the waterfall; step 224), and proceeding from step 214 and onward. Alternatively, if the waterfall ended, and the recall limit is reached, then a Filler Tag may be called (step 225).

Turning to FIG. 2D, the video item (or a direct link to the video item file) can be obtained based on the analyzed VAST data (step 231). The method then adds default trackers and/or custom (or customized) trackers, for the specific advertiser (step 232). The method then initiates a parallel process of video conversion (step 236, proceeding to the operations of step 241 and onward). In parallel to the video conversion being executed, the mobile video player is initiated (step 233) with the video link as a parameter. Other characteristics of the mobile video player are set (step 234), for example, color, style, size, buttons, background, or the like. The mobile video player is injected (step 235) to the HTML page of the end-user device (the mobile device), optionally showing a “spinner” or other countdown timer or progress indicator; then proceeding with the operations of step 251 and onward.

Turning to FIG. 2E, it shows the parallel process or concurrent process of video conversion; such that video conversion is initiated and carried out, in parallel to (or concurrently with) the initiating of the mobile video player (step 241). The video file itself is obtained based on the extracted link to the video file (step 242). If this particular video file was already processed or converted (step 243), then the previously-converted video may be re-used, and the operations proceed from step 251 and onward. Otherwise, the video file is processed (step 244), by generating a Sprite Sheet image or set-of-images per K frames (step 244), for example, K being equal to 8 or 10 or 12 or 16 frames. All the discrete images are synchronized to CDN (step 245). The method then sends to the mobile video player (step 246) at least: (i) the images folder location, and (ii) an indicator whether an audio track exists; and then proceeds with step 251 and onward.

Turning to FIG. 2F, the mobile video player is launched, and it optionally waits for the video ad to be ready (step 251). Once the video ad is ready (step 252), the mobile video player performs the playback, and “fires” or triggers all event trackers. The method further includes monitoring (listening to) all events (step 253), and saving or updating data in a “big data” platform or repository.

Other suitable methods or operations may be performed, in other suitable order of operations. Some embodiments may comprise or may enable additional features, for example: (1) Dynamic waterfall algorithm; such that according to one or more parameters (e.g., fill rate, error rate, price, device type, time of day) the system may change the priority on the demand source. (2) Timeout detector; for example, after a pre-defined timeout threshold value (e.g., 10 or 20 milliseconds) the system may not wait for response. (3) Support for Video Player Ad-serving Interface Definition (VPAID); for example, supporting JavaScript and/or Flash-based VPAID protocol. (4) Parallel call to the vendors using API calls; enabling to have all requests to video vendors performed at once or concurrently, instead of one after the other or serially. (5) Support for various other ad unit sizes. (6) White label support, in order to provide a customized solution to advertising agencies, trade-desks, and advertising networks as their mobile video player, enabling them to connect to leading demand sources. (7) Integration with DSPs and SSPs. (8) Automatic alerts platform for advertisers and publishers.

Some embodiments may support the following trackers, events and/or attributes:

Tracker/Event/Attribute (1): CreativeView—not to be confused with an impression, this event indicates that an individual creative portion of the ad was viewed. An impression indicates the first frame of the ad was displayed; however an ad may be composed of multiple creative, or creative that only play on some platforms and not others. This event enables ad servers to track which ad creative are viewed, and therefore, which platforms are more common.

Tracker/Event/Attribute (2): Start—this event is used to indicate that an individual creative within the ad was loaded and playback began. As with creativeView, this event is another way of tracking creative playback.

Tracker/Event/Attribute (3): firstQuartile—the creative played for at least 25% of the total duration.

Tracker/Event/Attribute (4): midpoint—the creative played for at least 50% of the total duration.

Tracker/Event/Attribute (5): thirdQuartile—the creative played for at least 75% of the duration.

Tracker/Event/Attribute (6): complete—The creative was played to the end at normal speed.

Tracker/Event/Attribute (7): mute—the user activated the mute control and muted the creative.

Tracker/Event/Attribute (8): unmute—the user activated the mute control and unmuted the creative.

Tracker/Event/Attribute (9): pause—the user clicked the pause control and stopped the creative.

Tracker/Event/Attribute (10): rewind—the user activated the rewind control to access a previous point in the creative timeline.

Tracker/Event/Attribute (11): resume—the user activated the resume control after the creative had been stopped or paused.

Tracker/Event/Attribute (12): fullscreen—the user activated a control to extend the video player to the edges of the viewer's screen.

Tracker/Event/Attribute (13): exitFullscreen—the user activated the control to reduce video player size to original dimensions.

Tracker/Event/Attribute (14): expand—the user activated a control to expand the creative.

Tracker/Event/Attribute (15): collapse—the user activated a control to reduce the creative to its original dimensions.

Tracker/Event/Attribute (16): acceptInvitationLinear—the user activated a control that launched an additional portion of the creative. The name of this event distinguishes it from the existing “acceptInvitation” event described in the 2008 IAB Digital Video In-Stream Ad Metrics Definitions, which defines the “acceptInivitation” metric as applying to non-linear ads only. The “acceptInvitationLinear” event extends the metric for use in Linear creative.

Tracker/Event/Attribute (17): closeLinear—the user clicked the close button on the creative. The name of this event distinguishes it from the existing “close” event described in the 2008 IAB Digital Video In-Stream Ad Metrics Definitions, which defines the “close” metric as applying to non-linear ads only. The “closeLinear” event extends the “close” event for use in Linear creative.

Tracker/Event/Attribute (18): skip—the user activated a skip control to skip the creative, which is a different control than the one used to close the creative.

Tracker/Event/Attribute (19): progress—the creative played for a duration at normal speed that is equal to or greater than the value provided in an additional attribute for offset. Offset values can be time in the format HH:MM:SS or HH:MM:SS.mmm or a percentage value in the format n %. Multiple progress events with different values can be used to track multiple progress points in the Linear creative timeline.

Some embodiments may further track other/additional parameters, for example: Publisher; Placement; Device model; GEO; user agent; Operating system; Fallbacks (no video ad); Ad size; Video file types; VAST URL; Source URL.

In some embodiments, the Tag (or code-portion) that is generated and utilized, may be in accordance with the following demonstrative example, shown as Code 1:

Code 1

```
<script>
  var params = {
  token: ‘token’,
  subid : ‘sub_id’,
  wfid: ‘watefall_id’,
  app: ‘app_name’,
  dps: ‘Source_name’,
  device: ‘${device_model}’,
  size: ‘size’,
  wl_path : ‘wfl_location’,
  wl_url : url’,
  trck_rl:=‘location
};
</script>
<script type=‘text/javascript’ src=‘location_js.js’></script>
```

In some embodiments, the Waterfall data-structure or code-structure or tag-structure that the present invention may generate and utilize, may be in accordance with the following demonstrative example, shown as Code 2:

Code 2

```
<?xml version=‘1.0’ encoding=‘UTF-8’?>
<waterfall id=‘10’ >
  <vast vastID=‘1’ name=‘partner’ adid=‘1809345’ ecpm=‘9’
type=‘client’>
    vast link example
  </vast>
</waterfall>
```

In accordance with the present invention, the system may generate and/or load VAST and/or VPAID tags, which cause redirecting to the mobile video ad(s). The system takes the video ads into one of the system's services, regardless of whether or not the video format is supported by the device, demand source, and/or supply source. Then the system modifies the video (or converts the video) into image stripes, separating it from the audio; and combing it back into the mobile video player which runs (plays-back) the video on the mobile device. In that manner, the system supports any video ad type, weight, size, bit-rate level, and video quality, and is able to play-back any such video in any mobile device, smartphone, tablet, smart-watch, wearable device, Augment Reality (AR) device, a device similar to Google Glass, smart TV, game consoles, portable gaming device, car screens, vehicular devices, dashboard devices, or the like. The system creates a full sync between the audio and the new video, allowing the user to pause the video, to increase/decrease the video ad size on the screen, and to mute/un-mute the audio.

When the user is watching the mobile video-ad, in real-time the system seeks for new demand, gets the new video ad from the demand partners, and prepares the (next) video/s to present to the user. When the current movie playback is completed, the new video-ad will run automatically.

The system further integrates with publishers that already have their own video player; allowing such publishers to have (to utilize) only the mobile video ad in accordance with the present invention, from the system's demand sources (and without requiring the publisher to get multiple versions of the video ad); and further providing to the demand partners new sources of supply.

The system may smartly match the right demand source (advertiser) to the specific supply source (publisher). For example, in real-time the system may determine to whom the system should present the mobile video ad, based on numerous targeting criteria, such as: completion rates, fill rate, Revenue eCPM, country, size, device, IP address, user, model, connection-type, latitude, longitude, location, operation system version, and/or other suitable parameters. Based on these, for each publisher, the system may generate and utilize a unique or publisher-tailored waterfall, which is a prioritized list for the system's demand partners. The waterfall if being modified dynamically in real time, by saving the data in a real-time repository or “big data” platform, pulling the data dynamically from such repository according to the publisher and user details, and modifying the Waterfall order by using past data. Furthermore, in real-time the system may determine to whom the system should not display videos at all, according to their buying history and strategy. This method may increase payout for the system's administrator and/or for the system's partners. In addition to the unique real-time modifiable waterfall, the system may utilize integration via API and/pr RTB (parallel connection) to partners that are able to connect that way; allowing to increase the fill rate, as well as revenue eCPM, by enabling selection of the demand source that provides the highest bids.

The system may deliver real-time trackers and may post back to the demand partners, based on their requirements that they are sending to the system with their VAST tags. The system may send all trackers that are defined or required by the IAB standard, or that are described above; for example, user details (such as: IP address, and IDFA), event's details (such as: when the movie was loaded, when it was paused, when the video ad ends), or the like. Additionally, upon demand, the system may dynamically add any tracker that a client needs, in a modular way and without requiring any further integration or installations. Some embodiments may allow storing of the trackers information in a dedicated log or repository, which operates as a real-time platform for reports, logging, error handling, and/or traffic shifting.

Some embodiments of the present invention may optionally take into account, when selecting and/or constructing an advertisement and/or a video-content-item, the current geo-spatial location of the electronic device or mobile device on which the content item is intended to be displayed or played-back; by taking into account or by using, for example, Global Positioning System (GPS) data, cellular triangulation data, nearest-cellular-cell data or identifier, wireless (e.g., Wi-Fi) network identifier or SSID data, a location-based indication that may be provided by the mobile device (e.g., recent scanning of a QR code or a two-dimensional barcode or code, or a “check in” operation), and/or other suitable data; as well as device-specific data or parameters (e.g., type of electronic device, maker, model, OS type, OS version, running application(s), installed application(s), screen resolution, current screen orientation (e.g., portrait or landscape), Web browser type or version; and/or other suitable parameters (e.g., time-of-day, or day-of-week, or calendar date; or information or date pertaining to the user or owner of the electronic device).

Some demonstrative embodiments of the present invention may be implemented by using one or more suitable hardware components and/or software modules, for example, processors, Central Processing Units (CPUs), Digital Signal Processors (DSPs), Integrated Circuits (ICs), controllers, logic circuits, operating systems, drivers, applications, “apps” or applications, mobile apps, input units, output units, storage units, memory units, wireless communication units or links or networks or transceivers, wired communication units or links or networks or transceivers, transmitters, receivers, transceivers, network cards, network adapters, Network Interface Cards (NICs), location-based units or modules or components, location-determining units or modules, GPS units or modules, or the like.

Discussions utilizing terms such as “processing”, “computing”, “calculating”, “determining”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In accordance with some demonstrative embodiments of the present invention, a computerized system may comprise: a video advertisements control unit to enable serving of a video advertisement to a mobile electronic device, wherein the video advertisements control unit may comprise: (a) a tag sending unit to send a unique publisher tag, to a plurality of advertising supply side servers of multiple advertisers; (b) a mobile video player loader unit, to automatically load a mobile video player upon parsing of said unique publisher tag; (c) a waterfall loader unit, to automatically load, concurrently with step (b), a unique waterfall data structure comprising a prioritized list of advertising demand-side resources; (d) an advertiser selector unit, to analyze said prioritized list of advertising demand-side resources, and to select from said prioritized list a particular advertiser which offers to pay a maximum price for a video advertising impression relative to other advertisers on said prioritized list; (e) a video advertisement reconstruction unit, comprising: (I) a video source type identifier unit, to identify a source type of a video advertising item, and (II) a video slicer unit to split the video advertising item to multiple video slices, and (III) a video merging unit to selectively reconstruct a merged video content item from one or more of the multiple video slices, and (IV) a converter unit to convert Video Ad Serving Template (VAST) data of said video advertising item into a corresponding JavaScript tag; (f) a player starter unit, to automatically trigger operation of a mobile video player that was loaded onto the mobile electronic device, to playback the merged video content item on the mobile electronic device.

In some embodiments, the tag sending unit is to send to the plurality of advertising supply side server said unique tag which comprises an HTML code-segment that triggers a website to server an impression of a video advertisement.

In some embodiments, the tag sending unit is to send to the plurality of advertising supply side server said unique tag which comprises an HTML code-segment that triggers a browser of a mobile electronic device to display on the mobile electronic device an impression of a video advertisement.

In some embodiments, the waterfall loader unit is to automatically load said unique waterfall data structure in which multiple advertisers are ranked based on an amount of price that each advertiser agrees to pay for video advertisement placement.

In some embodiments, the video advertisements control unit further comprises: a waterfall structure ordering unit, to re-order the prioritized list of advertising demand-side resources based on fill-rate; wherein an advertiser and a corresponding video content item are automatically selected based on a criterion that maximizes fill-rate of multiple video advertisements of multiple advertisers.

In some embodiments, the video advertisements control unit further comprises: a waterfall structure ordering unit, to re-order the prioritized list of advertising demand-side resources based on aggregated profitability for an administrator of the video advertisements control unit; wherein an advertiser and a corresponding video content item are automatically selected based on a criterion that maximizes aggregated profitability for multiple video advertisements of multiple advertisers.

In some embodiments, the video advertisements control unit further comprises: a waterfall structure recalling unit, to recall a particular demand-side advertiser multiple time within a single waterfall structure that pertains to a single offered video ad impression.

In some embodiments, the video advertisements control unit further comprises: a waterfall structure recalling unit, to recall a particular demand-side advertiser multiple time within a single waterfall structure that pertains to a single offered video ad impression, at multiple different time-points, based on a criterion that maximizes video advertisement fill-rate.

In some embodiments, the video advertisements control unit further comprises: a waterfall structure recalling unit, to recall a particular demand-side advertiser multiple time within a single waterfall structure that pertains to a single offered video ad impression, at multiple different time-points, based on a criterion that maximizes video advertisement fill-rate.

In some embodiments, the video advertisements control unit further comprises: a flexible reporting unit, (A) to automatically identify that a first advertiser utilizes a first VAST format; and (B) to automatically identify that a second advertiser utilizes a second, different, VAST format; and (C) to modify in real time a configuration of the video advertisements control unit to serve to each advertiser feedback information in a required VAST format.

In some embodiments, the video advertisements control unit comprises: a JavaScript controller unit, (a) to load a mobile video player immediately upon loading of a publisher tag, (b) to load a VAST reader file that reads one or more VAST structures that are associated with the waterfall data structure, (c) to generate at least (I) a link to an XML representation of the waterfall data structure, and (II) one or more tracker objects pre-populated with default values; and also: a VAST reader unit, (a) to read the one or more VAST data structures that are associated with the waterfall data structure according to a reading order that is determined based on order of appearance of the VAST data structures in the XML representation, (b) to add customized values into said one or more tracker objects based on actual content of the one or more VAST data structures; (c) to at least attempt to obtain a direct link for a video file intended for playback as said video advertisement item; (d) to fall-back to reading a second VAST data structure, indicated in said XML representation of the waterfall data structure, if a first VAST data structure is processed and returns at least one of: (I) no video advertisement demand by said first VAST, or (II) non-supported video file indicated by said first VAST.

In some embodiments, the VAST reader unit is (A) to detect that a particular VAST reading attempt returns a redirection response, and (B) to utilize a proxy service that performs a call from a computer server and obtains a non-redirecting URL to said JavaScript controller unit.

In some embodiments, the VAST reader unit comprises a recursive VAST handler, (A) to detect that a particular VAST reading attempt does not yield a direct link to a video file, and (B) to recursively extract an internal VAST data structure from said particular VAST, and (C) to recursively repeat steps (A) and (B) until successful extraction of said direct link to the video file.

In some embodiments, the system may comprise: a waterfall structure recall unit, to enable Real-Time Bidding (RTB) on price offered for video ad placement, by repeatedly searching multiple times for a particular demand-side bid which changes over time due to said particular demand-side bid being continuously modified by a bidding server.

In some embodiments, the system may comprise: an initiator unit, (A) to initiate the mobile video player, (B) to obtain the link to the video file intended for playback, and (C) to obtain a width parameter and a height parameter of the video file intended for playback. In some embodiments, the system may further comprise a video player loading handler, comprising: (A) a video converter triggering unit, to asynchronously call to a wrapper for a computerized video converter unit to convert the intended video file into a set of discrete images; (B) a synchronization unit, to automatically synchronize the images of said set of discrete images to a Content Delivery Network (CDN); (C) an image-set handler unit, to obtain said set of discrete images, to store said set of discrete images as a sprite-sheet folder, and to obtain an indicator of whether or not said intended video file includes an audio track. In some embodiments, the JavaScript controller unit is (I) to receive an indication, from the mobile video player unit, that said mobile video player unit is loaded and ready to run, and (II) then to trigger playback of the set of discrete images via said mobile video player, and (III) to monitor events occurring during playback, and (IV) to launch a corresponding event tracker upon identification of a monitored event.

In some embodiments, the video advertisements control unit further comprises: an attribute parser unit, (A) to parse a platform-constraint attribute indicating that said video content item is required by a corresponding advertiser to be served only to a mobile web application and not to a native non-web mobile application; and (B) to trigger playback of the video content item only through a mobile web application of the mobile electronic device, and not through a native non-web mobile application of the mobile electronic device.

In some embodiments, the video advertisements control unit further comprises: an attribute parser unit, (A) to parse a platform-constraint attribute indicating that said video content item is required by a corresponding advertiser to be served only to a native non-web mobile application and not to a mobile web application; and (B) to trigger playback of the video content item only through a to a mobile web application of the mobile electronic device, and not through a mobile web application of the mobile electronic device.

In some embodiments, the video advertisements control unit further comprises: an attribute parser unit, (A) to parse an auto-start attribute indicating whether or not said video content item is required by a corresponding advertiser to auto-start playback, and (B) if said auto-start attribute so indicates, to trigger a mobile video player running on the mobile electronic device to auto-start playback of said video content.

In some embodiments, the video advertisements control unit further comprises: an attribute parser unit, (A) to parse a scroll-view attribute indicating whether or not said video content item is to be placed below a first fold of web-page; and (B) if said scroll-view attribute so indicates, to trigger a mobile video player running on the mobile electronic device to start playback of said video content only if and when said web-page was manually scrolled down from the first fold downwardly to show at least a portion of the mobile video player.

In some embodiments, a machine-implemented method may comprise: at a video advertisements control unit, serving a video advertisement to a mobile electronic device, by performing: (a) at a tag sending unit, sending a unique publisher tag, to a plurality of advertising supply side servers of multiple advertisers; (b) at a mobile video player loader unit, automatically loading a mobile video player upon parsing of said unique publisher tag; (c) at a waterfall loader unit, automatically loading, concurrently with step (b), a unique waterfall data structure comprising a prioritized list of advertising demand-side resources; (d) at an advertiser selector unit, analyzing said prioritized list of advertising demand-side resources, and selecting from said prioritized list a particular advertiser which offers to pay a maximum price for a video advertising impression relative to other advertisers on said prioritized list; (e) at a video advertisement reconstruction unit, performing: (I) identifying a source type of a video advertising item, and (II) splitting the video advertising item to multiple video slices, and (III) selectively reconstructing a merged video content item from one or more of the multiple video slices, and (IV) converting Video Ad Serving Template (VAST) data of said video advertising item into a corresponding JavaScript tag; (f) at a player starter unit, automatically triggering operation of a mobile video player that was loaded onto the mobile electronic device, to playback the merged video content item on the mobile electronic device. In some embodiments, at least one of: the video advertisements control unit, the tag sending unit, the mobile video player loader unit, the waterfall loader unit, the advertiser selector unit, the video advertisement reconstruction unit, and the player starter unit, is implemented by utilizing at least a hardware component.

In some embodiments, the system or method may be implemented by using at least a hardware component; or by using a non-generic computer, or by using a machine that is not a generic computer and is not a general-purpose computer; for example, a machine able to collect and/or obtain and/or take into account location-based information or data, user-specific information or data, touch-data or gestures, touch-screen data or gestures, incoming and/or outgoing wireless communication signals, or the like.

Functions, operations, components and/or features described herein with reference to one or more embodiments of the present invention, may be combined with, or may be utilized in combination with, one or more other functions, operations, components and/or features described herein with reference to one or more other embodiments of the present invention.

While certain features of the present invention have been illustrated and described herein, many modifications, substitutions, changes, and equivalents may occur to those skilled in the art. Accordingly, the claims are intended to cover all such modifications, substitutions, changes, and equivalents

What is claimed is:

1. A computerized system comprising:
a video advertisements control unit to enable serving of a video advertisement to a mobile electronic device, wherein the video advertisements control unit comprises:
(a) a tag sending unit to send a unique publisher tag, to a plurality of advertising supply side servers of multiple advertisers;
(b) a mobile video player loader unit, to automatically load a mobile video player upon parsing of said unique publisher tag;
(c) a waterfall loader unit, to automatically load, concurrently with step (b), a unique waterfall data structure comprising a prioritized list of advertising demand-side resources;
(d) an advertiser selector unit, to analyze said prioritized list of advertising demand-side resources, and to select from said prioritized list a particular advertiser which offers to pay a maximum price for a video advertising impression relative to other advertisers on said prioritized list;
(e) a video advertisement reconstruction unit, comprising: (I) a video source type identifier unit, to identify a source type of a video advertising item, and (II) a video slicer unit to split the video advertising item to multiple video slices, and (III) a video merging unit to selectively reconstruct a merged video content item from one or more of the multiple video slices, and (IV) a converter unit to convert Video Ad Serving Template (VAST) data of said video advertising item into a corresponding JavaScript tag;
(f) a player starter unit, to automatically trigger operation of a mobile video player that was loaded onto the mobile electronic device, to playback the merged video content item on the mobile electronic device.

2. The computerized system of claim 1, wherein the tag sending unit is to send to the plurality of advertising supply side server said unique tag which comprises an HTML code-segment that triggers a website to server an impression of a video advertisement.

3. The computerized system of claim 1, wherein the tag sending unit is to send to the plurality of advertising supply side server said unique tag which comprises an HTML code-segment that triggers a browser of a mobile electronic device to display on the mobile electronic device an impression of a video advertisement.

4. The computerized system of claim 1, wherein the waterfall loader unit is to automatically load said unique waterfall data structure in which multiple advertisers are ranked based on an amount of price that each advertiser agrees to pay for video advertisement placement.

5. The computerized system of claim 1, wherein the video advertisements control unit further comprises:
a waterfall structure ordering unit, to re-order the prioritized list of advertising demand-side resources based on fill-rate; wherein an advertiser and a corresponding video content item are automatically selected based on a criterion that maximizes fill-rate of multiple video advertisements of multiple advertisers.

6. The computerized system of claim 1, wherein the video advertisements control unit further comprises:
a waterfall structure ordering unit, to re-order the prioritized list of advertising demand-side resources based on aggregated profitability for an administrator of the video advertisements control unit; wherein an advertiser and a corresponding video content item are automatically selected based on a criterion that maximizes aggregated profitability for multiple video advertisements of multiple advertisers.

7. The computerized system of claim 1, wherein the video advertisements control unit further comprises:
a waterfall structure recalling unit, to recall a particular demand-side advertiser multiple time within a single waterfall structure that pertains to a single offered video ad impression.

8. The computerized system of claim 1, wherein the video advertisements control unit further comprises:
a waterfall structure recalling unit, to recall a particular demand-side advertiser multiple time within a single waterfall structure that pertains to a single offered video ad impression, at multiple different time-points, based on a criterion that maximizes video advertisement fill-rate.

9. The computerized system of claim 1, wherein the video advertisements control unit further comprises:
a waterfall structure recalling unit, to recall a particular demand-side advertiser multiple time within a single waterfall structure that pertains to a single offered video ad impression, at multiple different time-points, based on a criterion that maximizes video advertisement fill-rate.

10. The computerized system of claim 1, wherein the video advertisements control unit further comprises:
a flexible reporting unit, (A) to automatically identify that a first advertiser utilizes a first VAST format; and (B) to automatically identify that a second advertiser utilizes a second, different, VAST format; and (C) to modify in real time a configuration of the video advertisements control unit to serve to each advertiser feedback information in a required VAST format.

11. The computerized system of claim 1, wherein the video advertisements control unit comprises:
a JavaScript controller unit, (a) to load a mobile video player immediately upon loading of a publisher tag, (b) to load a VAST reader file that reads one or more VAST structures that are associated with the waterfall data structure, (c) to generate at least (I) a link to an XML representation of the waterfall data structure, and (II) one or more tracker objects pre-populated with default values;
a VAST reader unit, (a) to read the one or more VAST data structures that are associated with the waterfall data structure according to a reading order that is determined based on order of appearance of the VAST data structures in the XML representation, (b) to add customized values into said one or more tracker objects based on actual content of the one or more VAST data structures; (c) to at least attempt to obtain a direct link for a video file intended for playback as said video advertisement item; (d) to fall-back to reading a second VAST data structure, indicated in said XML representation of the waterfall data structure, if a first VAST data structure is processed and returns at least one of: (I) no video advertisement demand by said first VAST, or (II) non-supported video file indicated by said first VAST.

12. The computerized system of claim 11, wherein the VAST reader unit is (A) to detect that a particular VAST reading attempt returns a redirection response, and (B) to utilize a proxy service that performs a call from a computer server and obtains a non-redirecting URL to said JavaScript controller unit.

13. The computerized system of claim 11, wherein the VAST reader unit comprises a recursive VAST handler, (A) to detect that a particular VAST reading attempt does not yield a direct link to a video file, and (B) to recursively extract an internal VAST data structure from said particular VAST, and (C) to recursively repeat steps (A) and (B) until successful extraction of said direct link to the video file.

14. The computerized system of claim 11, comprising:
a waterfall structure recall unit, to enable Real-Time Bidding (RTB) on price offered for video ad placement, by repeatedly searching multiple times for a particular demand-side bid which changes over time due to said particular demand-side bid being continuously modified by a bidding server.

15. The computerized system of claim 11, comprising:
an initiator unit, (A) to initiate the mobile video player, (B) to obtain the link to the video file intended for playback, and (C) to obtain a width parameter and a height parameter of the video file intended for playback;
a video player loading handler, comprising:
(A) a video converter triggering unit, to asynchronously call to a wrapper for a computerized video converter unit to convert the intended video file into a set of discrete images;
(B) a synchronization unit, to automatically synchronize the images of said set of discrete images to a Content Delivery Network (CDN);
(C) an image-set handler unit, to obtain said set of discrete images, to store said set of discrete images as a sprite-sheet folder, and to obtain an indicator of whether or not said intended video file includes an audio track;
wherein the JavaScript controller unit is (I) to receive an indication, from the mobile video player unit, that said mobile video player unit is loaded and ready to run, and (II) then to trigger playback of the set of discrete images via said mobile video player, and (III) to monitor events occurring during playback, and (IV) to launch a corresponding event tracker upon identification of a monitored event.

16. The computerized system of claim 1, wherein the video advertisements control unit further comprises:
an attribute parser unit, (A) to parse a platform-constraint attribute indicating that said video content item is required by a corresponding advertiser to be served only to a mobile web application and not to a native non-web mobile application; and (B) to trigger playback of the video content item only through a mobile web application of the mobile electronic device, and not through a native non-web mobile application of the mobile electronic device.

17. The computerized system of claim 1, wherein the video advertisements control unit further comprises:
an attribute parser unit, (A) to parse a platform-constraint attribute indicating that said video content item is required by a corresponding advertiser to be served only to a native non-web mobile application and not to a mobile web application; and (B) to trigger playback of the video content item only through a to a mobile web application of the mobile electronic device, and not through a mobile web application of the mobile electronic device.

18. The computerized system of claim 1, wherein the video advertisements control unit further comprises:
an attribute parser unit, (A) to parse an auto-start attribute indicating whether or not said video content item is required by a corresponding advertiser to auto-start playback, and (B) if said auto-start attribute so indicates, to trigger a mobile video player running on the mobile electronic device to auto-start playback of said video content.

19. The computerized system of claim 1, wherein the video advertisements control unit further comprises:
an attribute parser unit, (A) to parse a scroll-view attribute indicating whether or not said video content item is to be placed below a first fold of web-page; and (B) if said scroll-view attribute so indicates, to trigger a mobile video player running on the mobile electronic device to start playback of said video content only if and when said web-page was manually scrolled down from the first fold downwardly to show at least a portion of the mobile video player.

20. A machine-implemented method:
at a video advertisements control unit, serving a video advertisement to a mobile electronic device, by performing:
(a) at a tag sending unit, sending a unique publisher tag, to a plurality of advertising supply side servers of multiple advertisers;
(b) at a mobile video player loader unit, automatically loading a mobile video player upon parsing of said unique publisher tag;
(c) at a waterfall loader unit, automatically loading, concurrently with step (b), a unique waterfall data structure comprising a prioritized list of advertising demand-side resources;
(d) at an advertiser selector unit, analyzing said prioritized list of advertising demand-side resources, and selecting from said prioritized list a particular advertiser which offers to pay a maximum price for a video advertising impression relative to other advertisers on said prioritized list;
(e) at a video advertisement reconstruction unit, performing: (I) identifying a source type of a video advertising item, and (II) splitting the video advertising item to multiple video slices, and (III) selectively reconstructing a merged video content item from one or more of the multiple video slices, and (IV) converting Video Ad Serving Template (VAST) data of said video advertising item into a corresponding JavaScript tag;
(f) at a player starter unit, automatically triggering operation of a mobile video player that was loaded onto the mobile electronic device, to playback the merged video content item on the mobile electronic device;
wherein at least one of: the video advertisements control unit, the tag sending unit, the mobile video player loader unit, the waterfall loader unit, the advertiser selector unit, the video advertisement reconstruction unit, and the player starter unit, is implemented by utilizing at least a hardware component.
